(19) United States
(12) Patent Application Publication
(10) Pub. No.: US 2026/0247455 A1
(43) Pub. Date: Aug. 20, 2026

(54) MOBILE APPLICATION FOR INTERCEPTING PHONE CALLS AND INITIATING TWO-WAY RADIO COMMUNICATION SESSIONSR

(71) Applicant: ANYWAIR, LLC, Atlanta, GA (US)

(72) Inventor: David G. Tyson, Atlanta, GA (US)

(21) Appl. No.: 19/544,279

(22) Filed: Feb. 19, 2026

Related U.S. Application Data
(60) Provisional application No. 63/760,355, filed on Feb. 19, 2025.

(51) Int. Cl. H04W 76/10

(52) U.S. Cl. CPC H04W 76/10

(57) ABSTRACT

The present disclosure relates generally to wireless communication systems and methods, and more particularly to a mobile phone application that intercepts conventional phone calls and initiates two-way radio communication sessions between users over cellular data networks. A mobile phone application stored on a non-transitory computer-readable medium and executable by a processor of a mobile phone includes instructions that, when executed by the processor, cause the mobile phone to detect an initiation of a phone call by a user to a recipient via a cellular phone network, intercept the phone call prior to establishing a connection via the cellular phone network, transmit a two-way radio communication session initiation signal to a server, and establish a two-way radio communication session between the mobile phone and a mobile phone of the recipient over a cellular data connection, wherein the two-way radio communication session bypasses the cellular phone network.

### CROSS-REFERENCE TO RELATED APPLICATIONS

This application claims the benefit of U.S. Provisional Application Ser. No. 63/760,355, filed on 19 Feb. 2025, which is incorporated herein by reference in its entirety as if fully set forth below.

### FIELD OF INVENTION

The present disclosure relates to wireless communication systems and methods, and more particularly to a mobile phone application that intercepts conventional phone calls and initiates two-way radio communication sessions between users over cellular data networks.

### BACKGROUND

Wireless communication networks have evolved to provide various types of voice and data communication services to users. Most wireless communication systems offer interconnect voice communication services, also referred to as circuit-switched voice communication services, which utilize the public switched telephone network (PSTN) to establish voice calls between users. Another type of voice communication service is push-to-talk (PTT) voice communication service, also referred to as dispatch communication service, which involves half-duplex communication between two communication endpoints. Push-to-talk calls require floor control to ensure that only one endpoint has permission to talk at any particular time during the call. There are several basic types of push-to-talk calls, including call alerts, private calls, and group calls. Call alerts inform the caller whether the called party is available for a call without establishing a voice channel. Private calls involve establishing a voice channel between two endpoints, whereas group calls involve establishing a voice channel between more than two endpoints. Mobile devices, such as smartphones and tablets, are capable of utilizing conventional cellular data connections to transmit various types of data, including voice data, video data, and text data. Applications running on mobile devices can provide communication functionality that operates over cellular data networks rather than the traditional PSTN.

However, existing PTT communication services and other two-way radio communication systems have several limitations. Current PTT communication services do not run in the background without users knowing and must be manually activated by a user each time communication is desired. This manual activation requirement creates additional steps for users who wish to communicate and may result in delays when rapid communication is needed. Additionally, existing systems do not provide a seamless transition from conventional phone call initiation to two-way radio communication, requiring users to learn and utilize separate interfaces and procedures for different communication modes. Furthermore, current mobile phone applications do not leverage the physical action buttons present on the sides of smartphones to facilitate two-way radio functionality, leaving these hardware features underutilized for communication purposes.

What is needed, therefore, is a mobile phone application that can intercept conventional phone calls and automatically initiate two-way radio communication sessions between users over cellular data networks. Such an application would allow users to utilize familiar phone call initiation procedures while benefiting from two-way radio communication capabilities, and would enable the use of physical action buttons on mobile devices to facilitate the two-way radio communications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A mobile phone application stored on a non-transitory computer-readable medium and executable by a processor of a mobile phone can include instructions that, when executed by the processor, cause the mobile phone to detect an initiation of a phone call by a user to a recipient via a cellular phone network. The mobile phone application can include instructions that cause the mobile phone to intercept the phone call prior to establishing a connection via the cellular phone network. The mobile phone application can include instructions that cause the mobile phone to transmit a two-way radio communication session initiation signal to a server. The mobile phone application can include instructions that cause the mobile phone to establish a two-way radio communication session between the mobile phone and a mobile phone of the recipient over a cellular data connection, wherein the two-way radio communication session bypasses the cellular phone network.

A method for establishing a two-way radio communication session can include detecting, by a mobile phone application executing on a first mobile phone, an initiation of a phone call by a user of the first mobile phone to a second mobile phone via a cellular phone network. The method can include intercepting, by the mobile phone application, the phone call prior to establishing a connection via the cellular phone network. The method can include transmitting, by the mobile phone application, a two-way radio communication session initiation signal to a server. The method can include receiving, by the server, the two-way radio communication session initiation signal. The method can include initiating, by the server, a two-way radio communication session between the first mobile phone and the second mobile phone over a cellular data connection, wherein the two-way radio communication session bypasses the cellular phone network.

A system for two-way radio communication over cellular data can include a first mobile phone having a processor and a memory storing a mobile phone application executable by the processor. The system can include a second mobile phone. The system can include a server in communication with the first mobile phone and the second mobile phone over a cellular data network. The mobile phone application can be configured to detect an initiation of a phone call by a user of the first mobile phone to the second mobile phone via a cellular phone network. The mobile phone application can be configured to intercept the phone call prior to establishing a connection via the cellular phone network. The mobile phone application can be configured to transmit a two-way radio communication session initiation signal to the server. The server can be configured to establish a two-way radio communication session between the first mobile phone and the second mobile phone over the cellular data network, wherein the two-way radio communication session bypasses the cellular phone network.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a block diagram of an example communication network that may be used to provide two-way radio communication over cellular data, according to examples of the disclosed technology.

FIG. 2 is a block diagram of an example user equipment, according to examples of the disclosed technology.

FIG. 3 is a block diagram of an example base station, according to examples of the disclosed technology.

FIG. 4 is a block diagram of an example PoC server, according to examples of the disclosed technology.

FIG. 5A illustrates a sequence diagram for establishing a two-way radio communication session, according to examples of the disclosed technology.

FIG. 5B illustrates a sequence diagram for terminating a two-way radio communication session, according to examples of the disclosed technology.

FIG. 6 illustrates a sequence diagram for a two-way radio communication session process, according to examples of the disclosed technology.

FIG. 7 is a flow diagram for a method for establishing a two-way radio communication session, according to examples of the disclosed technology.

FIG. 8 is a flow diagram for a method for establishing a two-way radio communication session, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for establishing two-way radio communication over cellular data networks. In various embodiments, a mobile phone application can be configured to detect when a user initiates a conventional phone call and intercept the call prior to establishing a connection via a cellular phone network. The mobile phone application can then transmit a communication session initiation signal to a server, which can establish a two-way radio communication session between the user's mobile phone and a recipient's mobile phone over a cellular data connection. The two-way radio communication session can bypass the public switched telephone network (PSTN) and instead utilize cellular data infrastructure for voice and data transmission.

In some embodiments, the mobile phone application can operate transparently to the user, such that the user can utilize conventional call initiation methods (e.g., selecting a contact, dialing a phone number) while the application intercepts the intended call and redirects communication through a two-way radio session. The mobile phone application can run in a background of an operating system of the mobile phone, maintaining a continuous connection with a server to facilitate rapid establishment of two-way radio communication sessions when initiated by the user.

In various embodiments, the mobile phone application can utilize one or more action buttons disposed on sides of the mobile phone to facilitate two-way radio communications. The action buttons can provide a physical interface for the user to control aspects of the two-way radio communication session, such as initiating transmission, maintaining an active communication link, or terminating the session. In some embodiments, the two-way radio communication session can be maintained while the one or more action buttons are depressed, and the communication link can terminate when the one or more action buttons are released, thereby mimicking traditional two-way radio functionality.

The two-way radio communication session can support transmission of various types of data, including voice data, video data, text data, location data, and other information. In some embodiments, the communication can be encrypted end-to-end to provide secure communication between users of the mobile phone application. The server can manage session establishment, coordinate communication between multiple mobile phones, and handle session termination requests from participating devices.

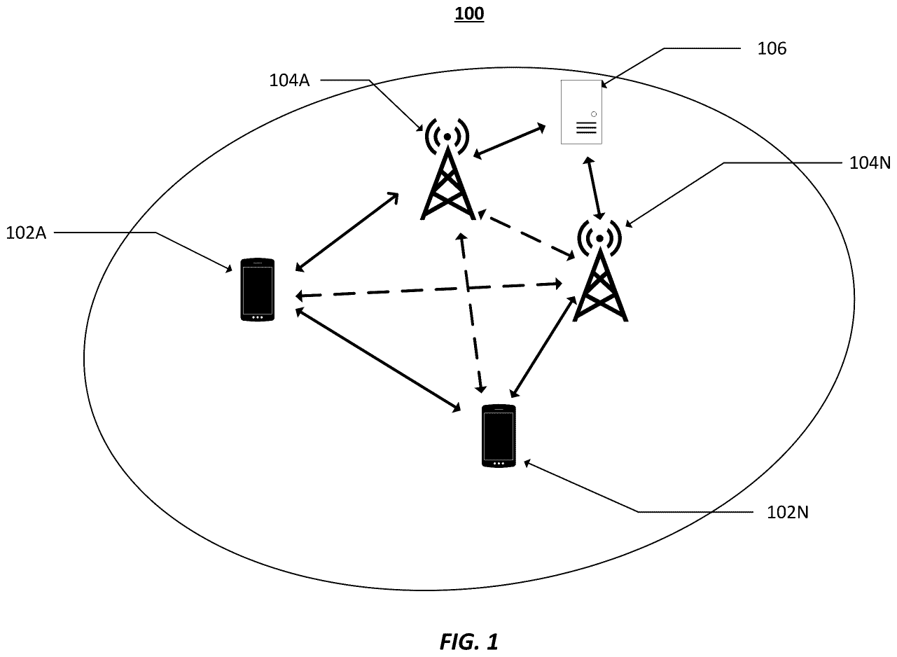

Referring to FIG. 1, a communication network 100 is illustrated in accordance with various embodiments of the present disclosure. The communication network 100 can include a first UE 102A, an additional UE 102N, a base station 104A, a base station 104N, and a PoC server 106. The first UE 102A and the additional UE 102N can be mobile phones, tablets, laptops, or other handheld devices capable of wireless communication. The first UE 102A can be referred to herein as a first mobile phone, and the additional UE 102N can be referred to herein as a second mobile phone. The first UE 102A can include a processor and a memory storing a mobile phone application executable by the processor, as described previously. The PoC server 106 can be referred to herein as a server, and the PoC server 106 can be in communication with the first UE 102A and the additional UE 102N over a cellular data network.

With continued reference to FIG. 1, the first UE 102A can be configured to communicate with one or more of the base station 104A, the additional UE 102N, the base station 104N, the PoC server 106, or a combination thereof. The base station 104A and the base station 104N can be wireless transmission towers configured to facilitate wireless communications within the communication network 100. The PoC server 106 can function to manage and coordinate two-way radio communication sessions within the communication network 100. Data can flow between the first UE 102A and the additional UE 102N through the base station 104A, the base station 104N, and the PoC server 106, enabling two-way radio communication over cellular infrastructure.

Depending on the communication technologies employed, the communication network 100 can be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network, or other suitable network types. Communications within the communication network 100 can conform to standards including New Radio Access (NR), Long Term Evolution (LTE), LTE-Evolution, LTE-Advanced (LTE-A), Wideband Code Division Multiple Access (WCDMA), Code Division Multiple Access (CDMA), CDMA2000, Global System for Mobile Communications (GSM), or other suitable standards.

As further shown in FIG. 1, communications within the communication network 100 can be performed according to first generation (1G), second generation (2G), 2.5G, 2.75G, third generation (3G), fourth generation (4G), 4.5G, or fifth generation (5G) new radio (NR) communication protocols. The communication network 100 can support various wireless networks and radio technologies, and future communication technologies and systems can be implemented within the communication network 100 as technology progresses.

In various embodiments, the communication network 100 can be a push-to-X over cellular (PoC) communication network. The PoC communication network can be configured to utilize network components including the first UE 102A, the additional UE 102N, the base station 104A, the base station 104N, and the PoC server 106 to set up and control radio resources. The PoC communication network and the PoC server 106 can be configured to establish and manage the switching of data and frequencies, including switching data to voice data, video data, message data, or other data types.

In some embodiments, the PoC communication network can be implemented as part of a Global System for Mobile communications (GSM) system, with the base station 104A and the base station 104N being GSM General Packet Radio Service (GPRS) radio access networks and packet data core networks being Gateway GPRS Support Nodes (GGSNs) and Serving GPRS Support Nodes (SGSNs). Alternatively, the PoC communication network can be implemented as part of a CDMA system. The PoC communication network can have additional or alternate radio access networks and core networks, including combinations and hybrids that develop as technology progresses.

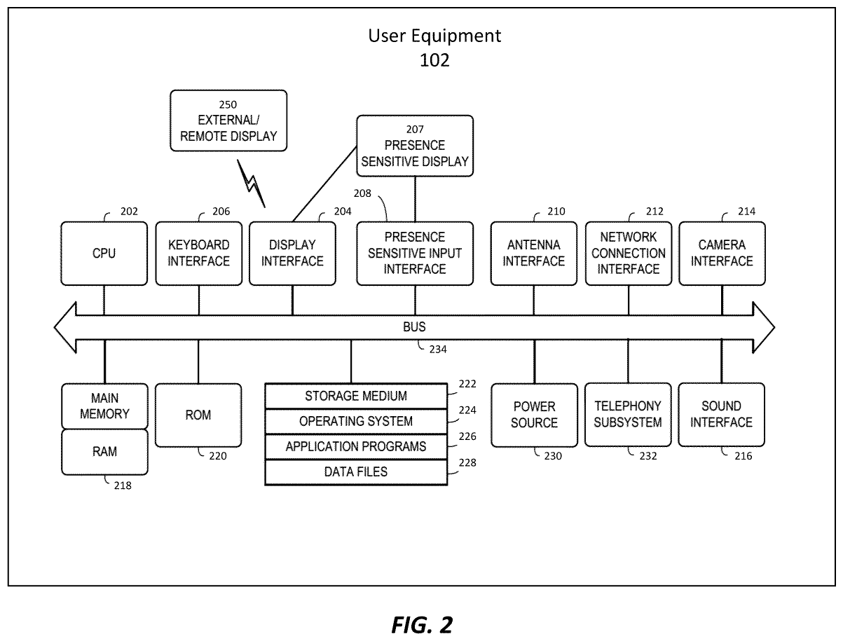

Referring to FIG. 2, an exemplary block diagram of a user equipment 102 is illustrated in accordance with various embodiments of the present disclosure. The user equipment 102 can be the first UE 102A or the additional UE 102N described with reference to FIG. 1. The user equipment 102 can include a central processing unit (CPU) 202 where computer instructions are processed. The CPU 202 can be referred to herein as a processor of a mobile phone. The user equipment 102 can further include a display interface 204 that acts as a communication interface and provides functions for rendering video, graphics, images, and texts on a display.

With continued reference to FIG. 2, the display interface 204 can be directly connected to a local display, such as a presence sensitive display 207 associated with the user equipment 102. The presence sensitive display 207 can be a touch-screen display configured to receive user input. The display interface 204 can also be configured for providing data, images, and other information for an external remote display 250 that is not physically connected to the user equipment 102. In some embodiments, the display interface 204 can wirelessly communicate via a network connection interface 212 to the external remote display 250.

The user equipment 102 can include a keyboard interface 206 that provides a communication interface to a keyboard. A presence sensitive input interface 208 can be coupled to the presence sensitive display 207 for receiving user input. The user equipment 102 can further include an antenna interface 210 that provides a communication interface to an antenna for wireless communication with the base station 104A, the base station 104N, and the PoC server 106 within the communication network 100.

As further shown in FIG. 2, the network connection interface 212 provides a communication interface to a network. The network connection interface 212 can include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, or other communication interfaces. The user equipment 102 can further include a camera interface 214 that provides connectivity for image capture functionality, and a sound interface 216 that provides audio input and output capabilities.

The user equipment 102 can include a random access memory (RAM) 218 where computer instructions and data can be stored in a volatile memory device for processing by the CPU 202. The RAM 218 can be referred to herein as a memory module of the mobile phone. A read only memory (ROM) 220 can store invariant low-level system code or data for basic system functions such as basic input and output, startup, or reception of keystrokes from a keyboard in a non-volatile memory device.

With continued reference to FIG. 2, the user equipment 102 can include a storage medium 222 where files including an operating system 224, application programs 226, and data files 228 are stored. The storage medium 222 can be a non-transitory computer-readable medium. The storage medium 222 can include one or more suitable types of memory such as volatile or non-volatile memory, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, redundant array of independent disks (RAID), or other suitable storage media.

The application programs 226 stored on the storage medium 222 can include a mobile phone application as described previously. The mobile phone application can be stored on the storage medium 222, which is a non-transitory computer-readable medium, and can be executable by the CPU 202 of the user equipment 102. The mobile phone application can comprise instructions that, when executed by the CPU 202, cause the user equipment 102 to detect an initiation of a phone call, intercept the phone call, transmit a two-way radio communication session initiation signal to the PoC server 106, and establish a two-way radio communication session. The instructions can further cause the user equipment 102 to store two-way radio communication session information in the RAM 218, which serves as a memory module of the mobile phone.

The user equipment 102 can further include a power source 230 that provides appropriate alternating current (AC) or direct current (DC) to power components of the user equipment 102. A telephony subsystem 232 can enable voice communication functionality for the user equipment 102. A bus 234 can interconnect the CPU 202, the RAM 218, the ROM 220, the storage medium 222, and other components of the user equipment 102, providing communication pathways for data transfer between the various elements.

In various embodiments, the CPU 202 can load computer-executable process steps from the storage medium 222 or other media into a field of the RAM 218 in order to execute software programs including the mobile phone application. Data can be stored in the RAM 218, where the data can be accessed by the CPU 202 during execution. The operating system 224 can provide the operating environment for the user equipment 102, and the mobile phone application can run in a background of the operating system 224 to maintain a continuous connection with the PoC server 106.

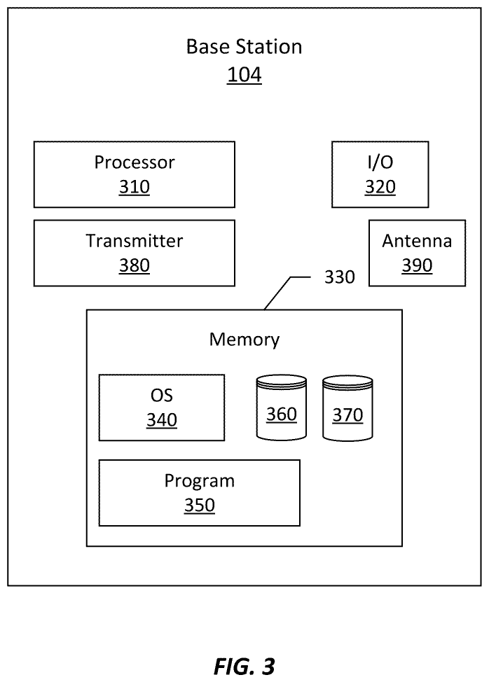

Referring to FIG. 3, an exemplary block diagram of the base station 104 is illustrated in accordance with various embodiments of the present disclosure. The base station 104 can be the base station 104A or the base station 104N described with reference to FIG. 1. The base station 104 can include a processor 310, an input/output (I/O) device 320, a memory 330, a transmitter 380, and an antenna 390. The processor 310 can be configured to execute instructions and process data for the base station 104. The I/O device 320 can provide communication interfaces for the base station 104 to interact with external devices and network components.

With continued reference to FIG. 3, the memory 330 can store data and instructions used to perform one or more features of the disclosed embodiments. The memory 330 can include one or more suitable types of memory such as volatile or non-volatile memory, RAM, ROM, PROM, EPROM, EEPROM, magnetic disks, optical disks, floppy disks, hard disks, removable cartridges, flash drives, or other suitable storage media. The memory 330 can contain an operating system (OS) 340, a program 350, and at least one database 360, 370.

The OS 340 can provide the operating environment for the base station 104. The program 350 can contain software components that, when executed by the processor 310, perform one or more processes consistent with the disclosed embodiments. The program 350 can include instructions for managing wireless communications between the user equipment 102 and the PoC server 106, handling handover procedures, and coordinating data transmission within the communication network 100.

As further shown in FIG. 3, the database 360 and a database 370 can store information for communication and to perform one or more of the processes and functionalities associated with the disclosed embodiments. The database 360 can store packet processing information, while the database 370 can store other data related to communication sessions, user equipment information, or network configuration data. The database 360 and the database 370 can be controlled by memory controller devices or software, such as document management systems, SQL databases, or other relational databases.

The transmitter 380 can be coupled to the antenna 390, enabling the base station 104 to communicate wirelessly with the first UE 102A, the additional UE 102N, other base stations, and the PoC server 106. The antenna 390 can transmit and receive wireless signals within the communication network 100. The transmitter 380 and the antenna 390 can facilitate the transmission of two-way radio communication session data between the user equipment 102 and the PoC server 106.

In various embodiments, the base station 104 can facilitate communication between the user equipment 102 and the PoC server 106 by receiving wireless signals from the first UE 102A or the additional UE 102N via the antenna 390 and routing the signals to the PoC server 106. The base station 104 can also receive signals from the PoC server 106 and transmit the signals to the first UE 102A or the additional UE 102N. The processor 310 can process incoming and outgoing data, manage resource allocation, handle interference management, perform load balancing, manage handover procedures, ensure quality of service, and perform power control functions.

With continued reference to FIG. 3, the base station 104 can include a geographic location sensor for determining the geographic location of the base station 104, the first UE 102A, the additional UE 102N, or the PoC server 106. The geographic location information can be used for mobility management, handover decisions, and location-based services within the communication network 100. The base station 104 can transmit two-way radio communication session information, two-way radio communication session service information, and two-way radio communication session data streams between the user equipment 102 and the PoC server 106 to establish and maintain two-way radio communication sessions over cellular data connections.

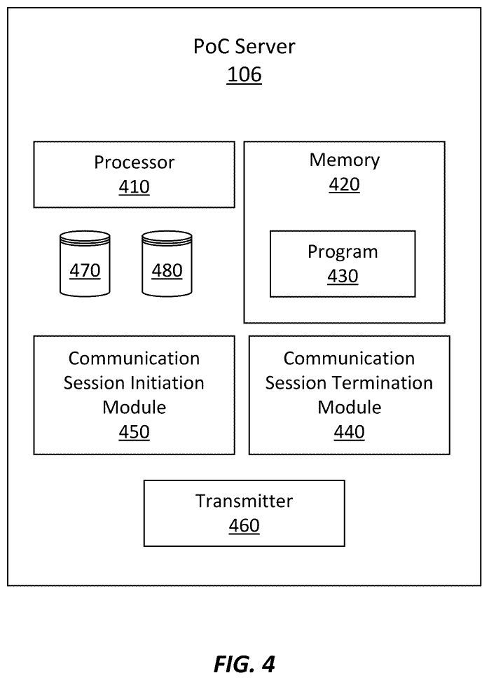

Referring to FIG. 4, an exemplary block diagram of the PoC server 106 is illustrated in accordance with various embodiments of the present disclosure. The PoC server 106 can include a processor 410, a memory 420, a program 430, a communication session termination module 440, a communication session initiation module 450, a transmitter 460, a database 470, and a database 480. The processor 410 can be configured to execute instructions and process data for the PoC server 106. The memory 420 can store data and instructions, and can include the program 430 which contains programmed instructions to perform the functions associated with the PoC server 106.

With continued reference to FIG. 4, the database 470 and the database 480 can be configured to store information related to communication sessions, user data, and other data for the operation of the PoC server 106. The communication session initiation module 450 can be configured to initiate two-way radio communication sessions between user equipment devices, while the communication session termination module 440 can be configured to handle the termination of two-way radio communication sessions. The transmitter 460 can be configured to transmit data and signals to the first UE 102A, the additional UE 102N, the base station 104A, the base station 104N, and other network components.

The communication session initiation module 450 and the communication session termination module 440 can be configured to communicate with the first UE 102A, the additional UE 102N, the base station 104A, the base station 104N, and one or more additional servers to control the communication functions of the PoC server 106. The processor 410, the memory 420, the program 430, the transmitter 460, and the database 470 and the database 480 can perform similarly to the corresponding components described with reference to FIG. 2 and FIG. 3.

As further shown in FIG. 4, the PoC server 106 can comprise a mobility management function. The mobility management function can configure the PoC server 106 to track the geographical location of the first UE 102A, the additional UE 102N, or other user equipment within the communication network 100. The mobility management function can manage handovers of at least one two-way radio communication session when the first UE 102A or the additional UE 102N moves between coverage areas of the base station 104A and the base station 104N. The mobility management function can ensure that at least one two-way radio communication session is maintained during movement of the first UE 102A or the additional UE 102N within the communication network 100.

The mobility management function can further manage at least one quality of service for the first UE 102A, the additional UE 102N, or other user equipment participating in two-way radio communication sessions. The mobility management function can assist with balancing at least one network load, including network slices, to optimize resource utilization within the communication network 100.

With continued reference to FIG. 4, the PoC server 106 can comprise a session management function. The session management function can configure the PoC server 106 to set up at least one two-way radio communication session between the first UE 102A, the additional UE 102N, the base station 104A, and the base station 104N. The session management function can ensure that at least one active two-way radio communication session is maintained and optimized during the two-way radio communication session. The session management function can handle termination of at least one two-way radio communication session when the first UE 102A or the additional UE 102N transmits a termination request. The session management function can assist with balancing at least one network load, including network slices, to optimize communication resources.

In various embodiments, the mobility management function and the session management function can be implemented within the PoC server 106, or the mobility management function and the session management function can be implemented within the base station 104A, the base station 104N, or a combination thereof.

The PoC server 106 can receive a PoC invitation message with PoC preferences and a message from an originating device such as the first UE 102A. The PoC preferences can determine with what user equipment to establish a two-way radio communication session and how many hops the call can be forwarded if the first-attempted device is not available. For example, if the additional UE 102N is not available when the first UE 102A initiates a two-way radio communication session, the PoC preferences can permit the PoC server 106 to forward the connection to additional servers, including a voicemail server or a recording server.

If one or more hops are allowed by the PoC preferences, the connection to a particular called party can be forwarded to additional servers including recording servers. A recorded message from the originating user can be sent to the recording server without interrupting a group call. The recorded message from the originating user can be selected or modified depending on the capabilities of the recording server. The PoC server 106 can send at least one additional invitation message to one or more additional servers if a trigger, such as time elapsed, occurs for the first-attempted device and the PoC preferences permit such forwarding.

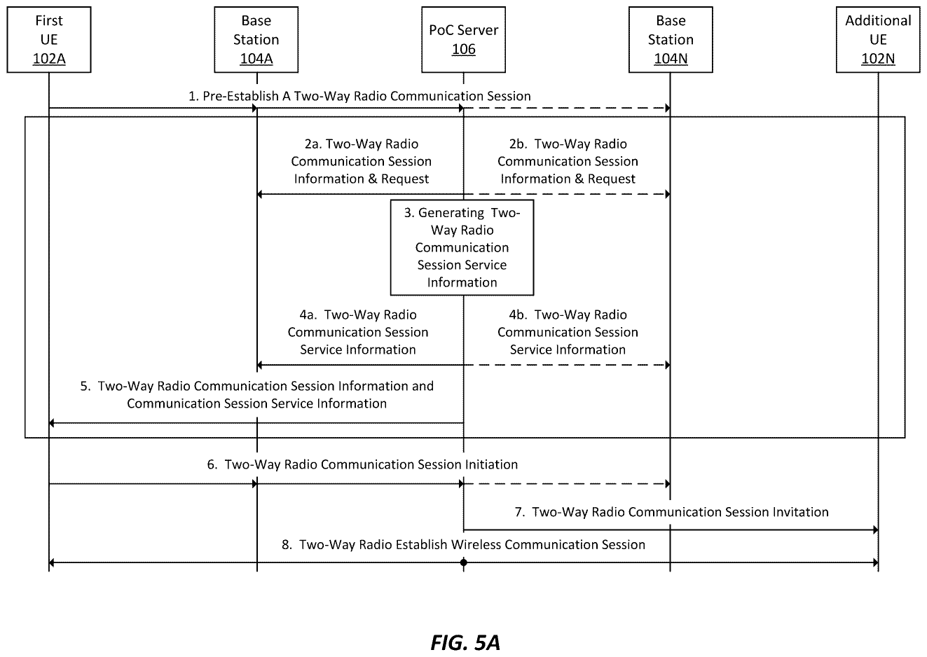

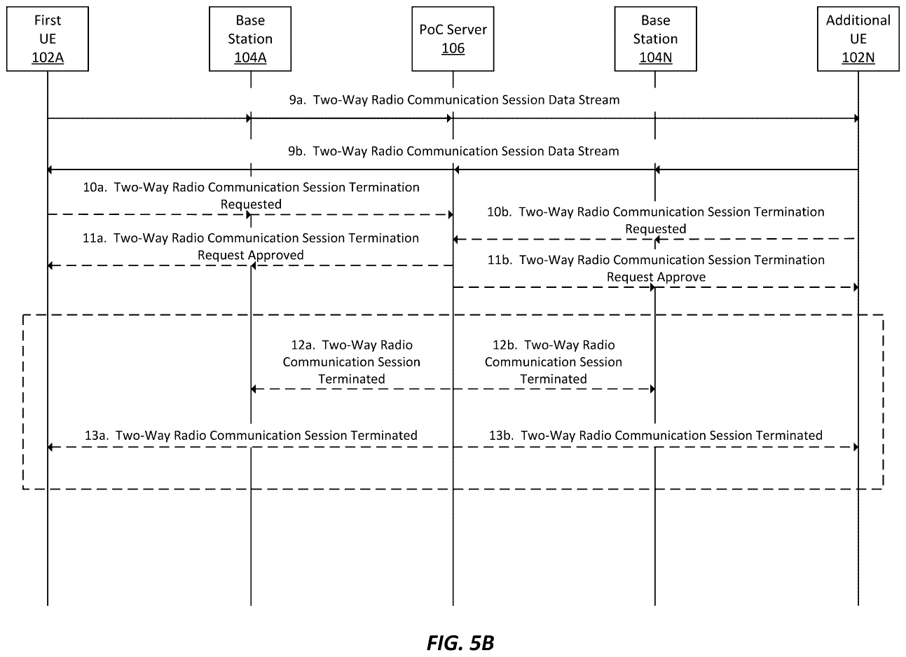

Referring to FIG. 5A, a sequence diagram representing a two-way radio communication session establishment process is illustrated in accordance with various embodiments of the present disclosure. The sequence diagram depicts the interaction flow between the first UE 102A, the additional UE 102N, the base station 104A, the base station 104N, and the PoC server 106 during the establishment of a two-way radio communication session over a cellular wireless communication network.

In various embodiments, the PoC server 106 can be configured to pre-establish a two-way radio communication session connection with the first UE 102A prior to detecting the initiation of a phone call. The pre-establishing session process can be performed automatically when the first UE 102A establishes a connection within the communication network 100, such as when the first UE 102A is powered on. The pre-establishing session process can involve transmitting two-way radio communication session information between the first UE 102A, the base station 104A, the base station 104N, and the PoC server 106.

With continued reference to FIG. 5A, the two-way radio communication session information can comprise information relating to control data, configuration data, user data, security data, or a combination thereof. The control data can comprise signaling information, handover information, resource allocation, and the like. The configuration data can comprise network configuration information, base station configuration information, network configuration update information, base station geographical location information, software update information, and the like. The user data can comprise user equipment information, subscriber information, usage statistics, or a combination thereof. The security data can comprise encryption data, authentication data, and the like.

In some embodiments, the two-way radio communication session information can further comprise locational data. The locational data can comprise locational data relating to the geographical location of the first UE 102A, the additional UE 102N, the base station 104A, the base station 104N, the PoC server 106, and the like. The locational data can be used for mobility management, handover decisions, and location-based services within the communication network 100.

As further shown in FIG. 5A, the PoC server 106 can receive the two-way radio communication session information from the first UE 102A via the base station 104A. In response to receiving the two-way radio communication session information, the PoC server 106 can generate two-way radio communication session service information. The two-way radio communication session service information can comprise session management information, quality of service (QoS) information, user data, control plane data information, network slicing information, mobility management information, or a combination thereof.

The PoC server 106 can transmit the generated two-way radio communication session service information to the base station 104A and the base station 104N. The base station 104A can transmit the two-way radio communication session information and the two-way radio communication session service information to the first UE 102A. The mobile phone application executing on the first UE 102A can receive, from the PoC server 106, the two-way radio communication session information prior to detecting the initiation of a phone call. The mobile phone application can store the two-way radio communication session information in a memory module of the first UE 102A to facilitate rapid establishment of two-way radio communication sessions.

With continued reference to FIG. 5A, the mobile phone application can maintain the two-way radio communication session connection in a background of an operating system of the first UE 102A. The two-way radio communication session connection can be a continuous connection, such that the first UE 102A is continuously connected with the PoC server 106. The two-way radio communication session connection can become idle in an instance in which the first UE 102A is powered off or in sleep mode, and the two-way radio communication session connection can be automatically reconnected once the first UE 102A is powered on or woken up.

In various embodiments, the mobile phone application can detect an initiation of a phone call by a user of the first UE 102A to the additional UE 102N via a cellular phone network. The user can initiate the phone call by dialing a phone number, pressing a saved phone number, selecting a saved contact, or other conventional call initiation methods. The mobile phone application can intercept the phone call prior to establishing a connection via the cellular phone network.

As further shown in FIG. 5A, in response to intercepting the phone call, the mobile phone application can transmit a two-way radio communication session initiation signal to the PoC server 106. The two-way radio communication session initiation signal can be transmitted via the base station 104A to the PoC server 106. The PoC server 106 can receive the two-way radio communication session initiation signal from the first UE 102A.

In response to receiving the two-way radio communication session initiation signal, the PoC server 106 can transmit a two-way radio communication session invitation to the additional UE 102N. The two-way radio communication session invitation can be transmitted via the base station 104N to the additional UE 102N. The PoC server 106 can initiate a two-way radio communication session between the first UE 102A and the additional UE 102N over a cellular data connection. The two-way radio communication session can bypass the cellular phone network, such that voice and data transmission occurs over cellular data infrastructure rather than the public switched telephone network (PSTN).

With continued reference to FIG. 5A, the PoC server 106 can establish a two-way radio communication session between the first UE 102A and the additional UE 102N over the cellular data network. The two-way radio communication session can utilize the cellular wireless communication network for data transmission while bypassing the cellular phone network for voice calls. The mobile phone application can operate transparently to the user, such that the user can utilize conventional call initiation methods while the mobile phone application intercepts the intended call and redirects communication through the two-way radio communication session.

Referring to FIG. 5B, a sequence diagram representing a two-way radio communication session data transmission and termination process is illustrated in accordance with various embodiments of the present disclosure. The sequence diagram depicts the continuation of the interaction flow between the first UE 102A, the additional UE 102N, the base station 104A, the base station 104N, and the PoC server 106 following the establishment of the two-way radio communication session as described with reference to FIG. 5A.

With continued reference to FIG. 5B, the first UE 102A and the additional UE 102N can transmit two-way radio communication session data between the devices during an active two-way radio communication session. In a step 9a, a two-way radio communication session data stream can be transmitted between the first UE 102A and the base station 104A, passing through the PoC server 106. Similarly, in a step 9b, a two-way radio communication session data stream can be transmitted between the additional UE 102N and the base station 104N, also passing through the PoC server 106. The mobile phone application can cause the first UE 102A to transmit two-way radio communication session data comprising voice data, video data, text data, location data, or a combination thereof. The two-way radio communication session data can further comprise status data, telemetry data, geographic location data, machine-to-machine data, internet of things data, real-time data, enhanced mobile broadband data, ultra-reliable low-latency communication data, augmented reality data, virtual reality data, or a combination thereof.

As further shown in FIG. 5B, the termination sequence begins when the first UE 102A or the additional UE 102N initiates a termination request. In a step 10a, a two-way radio communication session termination request signal can be sent from the first UE 102A through the base station 104A to the PoC server 106. In a step 10b, a corresponding two-way radio communication session termination request signal can be sent from the additional UE 102N through the base station 104N to the PoC server 106. The mobile phone application can cause the first UE 102A to transmit a two-way radio communication session termination request to the PoC server 106 in response to the user ending the two-way radio communication session. The two-way radio communication session termination request can be triggered by ending a call, closing an application, the first UE 102A or the additional UE 102N moving out of coverage, closing a tap, clicking a link, disconnecting Wi-Fi, disconnecting cellular coverage, disconnecting Bluetooth, powering off the first UE 102A or the additional UE 102N, or sleeping the first UE 102A or the additional UE 102N.

With continued reference to FIG. 5B, in response to receiving the two-way radio communication session termination request, the PoC server 106 can transmit approval signals. In a step 11a, a two-way radio communication session request approved signal can be sent from the PoC server 106 through the base station 104A to the first UE 102A. In a step 11b, a two-way radio communication session request approved signal can be sent from the PoC server 106 through the base station 104N to the additional UE 102N. The two-way radio communication session request approved signal can comprise a release command that confirms to the first UE 102A or the additional UE 102N that the PoC server 106 has received the termination request and has approved the termination.

The PoC server 106 can then transmit termination signals to the base station 104A and the base station 104N. In a step 12a, a two-way radio communication session terminated signal can be sent from the PoC server 106 to the base station 104A. In a step 12b, a two-way radio communication session terminated signal can be sent from the PoC server 106 to the base station 104N.

As further shown in FIG. 5B, the base station 104A and the base station 104N can transmit termination confirmation signals to the respective user equipment. In a step 13a, a two-way radio communication session terminated signal can be sent from the base station 104A to the first UE 102A. In a step 13b, a two-way radio communication session terminated signal can be sent from the base station 104N to the additional UE 102N. The step 13a and the step 13b can cause the first UE 102A and the additional UE 102N to terminate the two-way radio communication session.

Upon termination of the two-way radio communication session, the PoC server 106 can be configured to perform cleanup tasks. The cleanup tasks can include updating session records to reflect the termination of the two-way radio communication session. The cleanup tasks can further include releasing any remaining resources that were allocated for the two-way radio communication session, such as network bandwidth, memory allocations, or processing resources. The cleanup tasks can also include logging the session termination for billing or analytics purposes, such that usage data can be recorded for subscriber billing, network performance analysis, or service quality monitoring. The communication session termination module 440 of the PoC server 106 can handle the cleanup tasks and coordinate with the database 470 and the database 480 to update session records and store logging information.

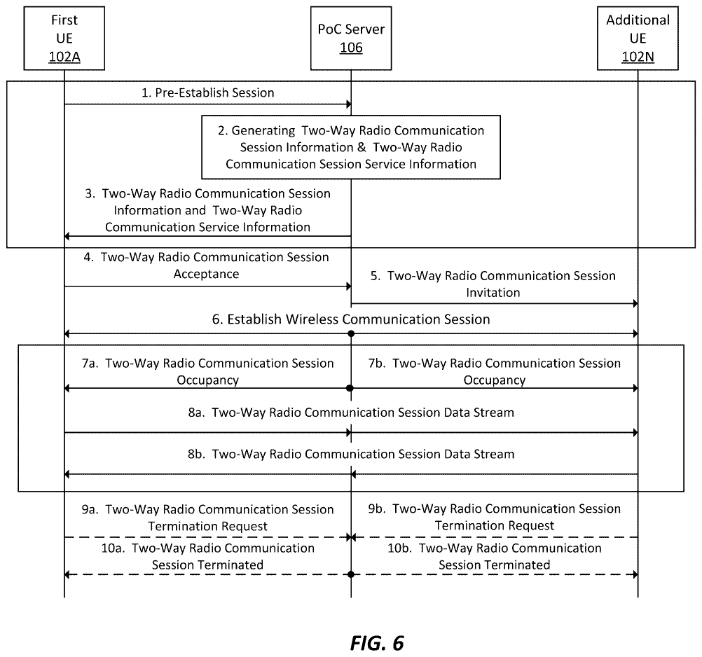

Referring to FIG. 6, a sequence diagram representing an alternative two-way radio communication session process is illustrated in accordance with various embodiments of the present disclosure. In the alternative process depicted in FIG. 6, the PoC server 106 can be configured to act as both the server and at least one base station, such that the PoC server 106 can communicate directly with the first UE 102A and the additional UE 102N without requiring separate base station components to relay communications.

With continued reference to FIG. 6, the first UE 102A can be configured to pre-establish a session with the PoC server 106. The pre-establishing session process can be performed automatically when the first UE 102A establishes a connection within the communication network 100. The PoC server 106 can generate two-way radio communication session information and two-way radio communication session service information in response to the pre-establishing session request from the first UE 102A. The two-way radio communication session service information can comprise session management information, quality of service (QoS) information, user data, control plane data information, network slicing information, mobility management information, or a combination thereof. The two-way radio communication session information can comprise information relating to control data, configuration data, user data, security data, or a combination thereof.

As further shown in FIG. 6, the PoC server 106 can transmit the two-way radio communication session information and the two-way radio communication session service information directly to the first UE 102A. The mobile phone application executing on the first UE 102A can receive the two-way radio communication session information and the two-way radio communication session service information from the PoC server 106. The mobile phone application can store the two-way radio communication session information in a memory module of the first UE 102A.

In response to receiving the two-way radio communication session information and the two-way radio communication session service information, the first UE 102A can transmit a two-way radio communication session acceptance signal to the PoC server 106. The acceptance signal can establish a two-way radio communication session connection between the first UE 102A and the PoC server 106. The two-way radio communication session connection can be a continuous connection, such that the first UE 102A is continuously connected with the PoC server 106. The two-way radio communication session connection can become idle in an instance in which the first UE 102A is powered off or in sleep mode, and the two-way radio communication session connection can be automatically reconnected once the first UE 102A is powered on or woken up. The mobile phone application can maintain the two-way radio communication session connection in a background of an operating system of the first UE 102A, such that the user can be unaware that the two-way radio communication session connection is active.

With continued reference to FIG. 6, when the mobile phone application detects an initiation of a phone call by a user of the first UE 102A to the additional UE 102N, the mobile phone application can intercept the phone call and transmit a two-way radio communication session initiation signal to the PoC server 106. In response to receiving the two-way radio communication session initiation signal, the PoC server 106 can transmit a two-way radio communication session invitation directly to the additional UE 102N. The two-way radio communication session invitation can prompt the additional UE 102N to join the two-way radio communication session with the first UE 102A.

In various embodiments, the additional UE 102N can be presented with an option to receive the call as a conventional call via the public switched telephone network (PSTN) or as a radio communication session. The mobile phone application executing on the additional UE 102N can display a user interface element that allows a user of the additional UE 102N to select between receiving the incoming communication as a conventional phone call or as a two-way radio communication session. If the user of the additional UE 102N selects the two-way radio communication session option, the additional UE 102N can establish a wireless communication session with the first UE 102A through the PoC server 106. If the user of the additional UE 102N selects the conventional call option, the communication can be routed through the PSTN instead of the two-way radio communication session.

As further shown in FIG. 6, the PoC server 106 can transmit two-way radio communication session occupancy information to the first UE 102A and the additional UE 102N. The two-way radio communication session occupancy information can comprise session utilization information, resource occupancy information, quality of service information, network performance information, user equipment performance information, security information, or a combination thereof. The session utilization information can indicate how much of the allocated session resources are being used. The resource occupancy information can indicate the availability of network resources for the two-way radio communication session. The quality of service information can indicate the current quality metrics of the two-way radio communication session. The network performance information can indicate the performance characteristics of the communication network 100. The user equipment performance information can indicate the performance characteristics of the first UE 102A and the additional UE 102N. The security information can indicate the security status of the two-way radio communication session.

With continued reference to FIG. 6, the first UE 102A and the additional UE 102N can transmit two-way radio communication session data streams between the devices through the PoC server 106. The two-way radio communication session can be a push-to-X communication session, wherein the first UE 102A and the additional UE 102N can communicate simultaneously using full-duplex transmission. The full-duplex transmission can allow both the first UE 102A and the additional UE 102N to transmit and receive data at the same time, rather than requiring one device to wait while the other device transmits.

The full-duplex transmission can be achieved through time-division duplexing (TDD), frequency-division duplexing (FDD), or a combination thereof. In embodiments utilizing TDD, the full-duplex transmission can be achieved by alternating one or more transmission and reception in one or more time slots. The first UE 102A and the additional UE 102N can transmit data during designated time slots and receive data during other designated time slots, with the time slots alternating rapidly to provide the appearance of simultaneous communication. In embodiments utilizing FDD, the full-duplex transmission can be achieved by using at least one different frequency band between the first UE 102A and the additional UE 102N for transmitting and receiving data. The first UE 102A can transmit data on a first frequency band while receiving data on a second frequency band, and the additional UE 102N can transmit data on the second frequency band while receiving data on the first frequency band.

In various embodiments, the PoC server 106 can be configured to determine at least one two-way radio communication session group. The two-way radio communication session group can comprise the first UE 102A, a second UE, and at least one additional UE 102N for group communication. The PoC server 106 can manage the two-way radio communication session group by coordinating communication between all participating user equipment devices. The two-way radio communication session group can allow multiple users to participate in a single two-way radio communication session, such that voice data, video data, text data, location data, or other data can be transmitted between all members of the group simultaneously.

The first UE 102A and the additional UE 102N can transmit two-way radio communication session termination requests to the PoC server 106 to end the two-way radio communication session. In response to receiving the termination requests, the PoC server 106 can transmit two-way radio communication session terminated signals to the first UE 102A and the additional UE 102N. Upon termination of the two-way radio communication session, the PoC server 106 can perform cleanup tasks including updating session records, releasing remaining resources, and logging the session termination for billing or analytics purposes.

In various embodiments, the mobile phone application can receive input from one or more action buttons on sides of the mobile phone to facilitate the two-way radio communication session. The one or more action buttons can be physical buttons disposed on lateral surfaces of the mobile phone, such as volume buttons, power buttons, or dedicated action buttons configured for two-way radio functionality. The mobile phone application can monitor the state of the one or more action buttons and respond to user input received through the one or more action buttons during an active two-way radio communication session.

The one or more action buttons can provide a physical interface for the user to control aspects of the two-way radio communication session. When the user depresses one or more of the action buttons, the mobile phone application can detect the button press and initiate or maintain voice transmission during the two-way radio communication session. The two-way radio communication session can be maintained while the one or more action buttons are depressed, such that voice data and other communication data are transmitted from the mobile phone to the recipient's mobile phone through the server. When the one or more action buttons are released, the two-way radio communication session can terminate, or the voice transmission can cease while the session remains active for receiving incoming communications. In some embodiments, the two-way radio communication session terminates when the one or more action buttons are released, thereby mimicking traditional two-way radio push-to-talk functionality where communication occurs while a button is held and ceases when the button is released.

The mobile phone application can be configured to maintain a continuous two-way radio communication session connection with the server that runs in a background of an operating system of the mobile phone. The continuous connection can allow the mobile phone application to rapidly establish two-way radio communication sessions when the user initiates a phone call, without requiring the mobile phone application to first establish a connection with the server. The background operation of the mobile phone application can be transparent to the user, such that the user can be unaware that the mobile phone application is running and maintaining the continuous connection with the server.

The two-way radio communication session connection can become idle when the mobile phone is powered off or in sleep mode. When the mobile phone enters a powered off state or a sleep mode state, the mobile phone application can suspend active communication with the server while preserving session state information in memory. The two-way radio communication session connection can automatically reconnect once the mobile phone is powered on or woken up from sleep mode. Upon powering on or waking from sleep mode, the mobile phone application can detect the change in device state and re-establish the continuous two-way radio communication session connection with the server using the stored session state information. The automatic reconnection behavior can ensure that the mobile phone application is ready to intercept phone calls and establish two-way radio communication sessions without requiring manual intervention from the user.

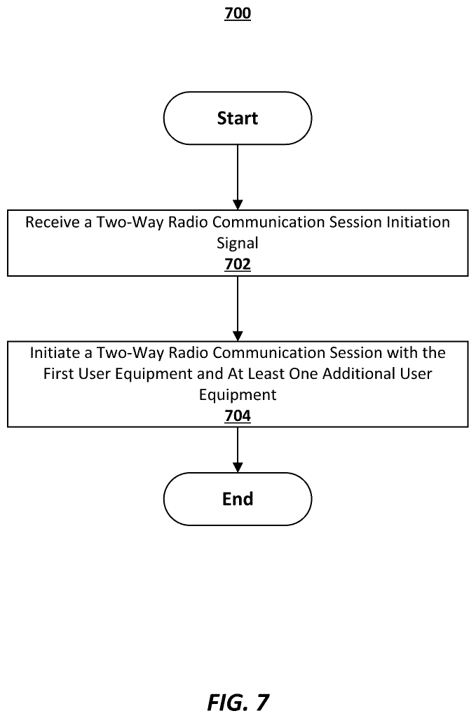

Referring to FIG. 7, a flowchart for a method 700 for establishing a two-way radio communication session is illustrated in accordance with various embodiments of the present disclosure. The method 700 can be implemented by the PoC server 106 described with reference to FIG. 1 and FIG. 4. The method 700 begins at a Start terminal and proceeds through a series of steps to establish a two-way radio communication session between the first UE 102A and the additional UE 102N within the communication network 100.

With continued reference to FIG. 7, the method 700 proceeds to a step 702, where a two-way radio communication session initiation signal is received. In various embodiments, the two-way radio communication session initiation signal can be received via the PoC server 106 from the first UE 102A. The two-way radio communication session initiation signal can be transmitted to the PoC server 106 via the base station 104A. The two-way radio communication session initiation signal can be transmitted in response to a user input with the first UE 102A. The user input can be the initiation of a phone call, such that data is streamed over the two-way radio communication session within the communication network 100.

In various embodiments, the user input that causes transmission of the two-way radio communication session initiation signal can be one or more of dialing a phone number, pressing a saved phone number, selecting a saved contact, scanning a QR code, sending a short message service, tapping the first UE 102A to the additional UE 102N, connecting to the additional UE 102N via Bluetooth, selecting a link, joining a group, or a combination thereof. When the user dials a phone number using a dialer interface of the first UE 102A, the mobile phone application can detect the dialing action and transmit the two-way radio communication session initiation signal to the PoC server 106. When the user presses a saved phone number from a call history or favorites list, the mobile phone application can intercept the call initiation and transmit the two-way radio communication session initiation signal. When the user selects a saved contact from a contacts application of the first UE 102A, the mobile phone application can detect the contact selection and transmit the two-way radio communication session initiation signal.

As further shown in FIG. 7, the user input can also include scanning a QR code displayed on a surface or another device. The mobile phone application can detect the QR code scan via the camera interface 214 of the first UE 102A and extract communication information from the QR code to transmit the two-way radio communication session initiation signal. The user input can include sending a short message service (SMS) message, where the mobile phone application can detect the SMS initiation and redirect the communication to a two-way radio communication session. The user input can include tapping the first UE 102A to the additional UE 102N using near-field communication (NFC) via the network connection interface 212, where the mobile phone application can detect the NFC tap and transmit the two-way radio communication session initiation signal.

The user input can further include connecting to the additional UE 102N via Bluetooth through the network connection interface 212. The mobile phone application can detect the Bluetooth connection request and transmit the two-way radio communication session initiation signal to the PoC server 106. The user input can include selecting a link, such as a hyperlink in a message, email, or web page, where the mobile phone application can detect the link selection and transmit the two-way radio communication session initiation signal. The user input can include joining a group, where the user selects a predefined group of contacts for group communication, and the mobile phone application can transmit the two-way radio communication session initiation signal to establish a group two-way radio communication session.

With continued reference to FIG. 7, following the step 702, the method 700 proceeds to a step 704, where a two-way radio communication session is initiated with the first UE 102A and the additional UE 102N. In various embodiments, the two-way radio communication session can be automatically initiated via the PoC server 106 in response to receiving the two-way radio communication session initiation signal. The communication session initiation module 450 of the PoC server 106 can process the two-way radio communication session initiation signal and coordinate the establishment of the two-way radio communication session between the first UE 102A and the additional UE 102N.

The two-way radio communication session can utilize the communication network 100 to transmit data between the first UE 102A and the additional UE 102N. The two-way radio communication session can transmit data from the first UE 102A to the base station 104A and from the additional UE 102N to the base station 104N. The data can be further transmitted to the PoC server 106 for routing between the first UE 102A and the additional UE 102N. The method 700 then proceeds to an End terminal, completing the process for establishing the two-way radio communication session.

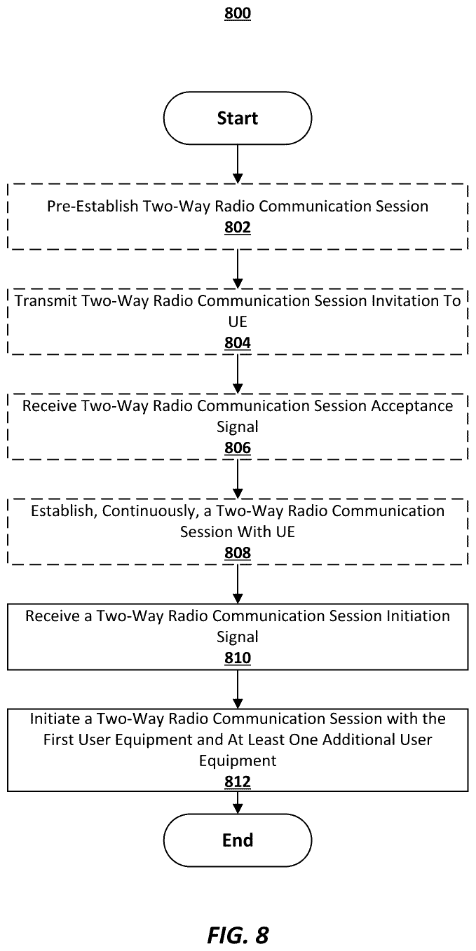

Referring to FIG. 8, a flowchart for a method 800 for establishing a two-way radio communication session is illustrated in accordance with various embodiments of the present disclosure. The method 800 can be implemented by the PoC server 106 described with reference to FIG. 1 and FIG. 4. The method 800 begins at a Start terminal and proceeds through a series of steps to pre-establish and initiate a two-way radio communication session between the first UE 102A and the additional UE 102N within the communication network 100. The method 800 provides an alternative embodiment to the method 700 described with reference to FIG. 7, wherein the method 800 includes pre-establishing a two-way radio communication session connection prior to receiving a session initiation signal from a user.

With continued reference to FIG. 8, the method 800 proceeds to a step 802, where a two-way radio communication session is pre-established. In various embodiments, the PoC server 106 can pre-establish a two-way radio communication session connection with the first UE 102A prior to detecting the initiation of a phone call by a user of the first UE 102A. The pre-establishing of the two-way radio communication session can be performed automatically when the first UE 102A establishes a connection within the communication network 100, such as when the first UE 102A is powered on or connects to the base station 104A. The pre-establishing of the two-way radio communication session can involve transmitting two-way radio communication session information between the PoC server 106 and the first UE 102A via the base station 104A.

The two-way radio communication session information transmitted during the step 802 can comprise control data, configuration data, user data, security data, or a combination thereof. The control data can comprise signaling information, handover information, and resource allocation information. The configuration data can comprise network configuration information, base station configuration information, and software update information. The user data can comprise user equipment information, subscriber information, and usage statistics. The security data can comprise encryption data and authentication data. The mobile phone application executing on the first UE 102A can store the two-way radio communication session information in the RAM 218 of the first UE 102A to facilitate rapid establishment of two-way radio communication sessions when initiated by the user.

As further shown in FIG. 8, the method 800 proceeds to a step 804, where a two-way radio communication session invitation is transmitted to a UE. In various embodiments, the PoC server 106 can transmit the two-way radio communication session invitation to the first UE 102A via the base station 104A. The two-way radio communication session invitation can comprise the two-way radio communication session information and two-way radio communication session service information generated by the PoC server 106. The two-way radio communication session service information can comprise session management information, quality of service (QoS) information, control plane data information, network slicing information, and mobility management information. The two-way radio communication session invitation can prompt the first UE 102A to accept the pre-established two-way radio communication session connection with the PoC server 106.

With continued reference to FIG. 8, the method 800 proceeds to a step 806, where a two-way radio communication session acceptance signal is received. In various embodiments, the PoC server 106 can receive the two-way radio communication session acceptance signal from the first UE 102A via the base station 104A. The two-way radio communication session acceptance signal can indicate that the mobile phone application executing on the first UE 102A has accepted the two-way radio communication session invitation and is ready to establish a continuous two-way radio communication session connection with the PoC server 106. The mobile phone application can transmit the two-way radio communication session acceptance signal automatically in response to receiving the two-way radio communication session invitation, without requiring user intervention.

The method 800 proceeds to a step 808, where a two-way radio communication session is established continuously with the UE. In various embodiments, the PoC server 106 can establish a continuous two-way radio communication session connection with the first UE 102A in response to receiving the two-way radio communication session acceptance signal. The continuous two-way radio communication session connection can be maintained in a background of the operating system 224 of the first UE 102A, such that the user can be unaware that the two-way radio communication session connection is active. The continuous two-way radio communication session connection can allow the mobile phone application to rapidly establish two-way radio communication sessions with the additional UE 102N when the user initiates a phone call.

As further shown in FIG. 8, the continuous two-way radio communication session connection established in the step 808 can become idle in an instance in which the first UE 102A is powered off or in sleep mode. The continuous two-way radio communication session connection can be automatically reconnected once the first UE 102A is powered on or woken up from sleep mode. The mobile phone application can detect the change in device state and re-establish the continuous two-way radio communication session connection with the PoC server 106 using the stored two-way radio communication session information in the RAM 218.

With continued reference to FIG. 8, the method 800 proceeds to a step 810, where a two-way radio communication session initiation signal is received. In various embodiments, the PoC server 106 can receive the two-way radio communication session initiation signal from the first UE 102A via the base station 104A. The two-way radio communication session initiation signal can be transmitted in response to a user input with the first UE 102A. The user input can be the initiation of a phone call to the additional UE 102N, wherein the mobile phone application detects the phone call initiation and intercepts the phone call prior to establishing a connection via a cellular phone network. The user input can be one or more of dialing a phone number, pressing a saved phone number, selecting a saved contact, scanning a QR code, sending a short message service, tapping the first UE 102A to the additional UE 102N, connecting to the additional UE 102N via Bluetooth, selecting a link, joining a group, or a combination thereof.

The method 800 proceeds to a step 812, where a two-way radio communication session is initiated with the first UE 102A and the additional UE 102N. In various embodiments, the PoC server 106 can automatically initiate the two-way radio communication session between the first UE 102A and the additional UE 102N in response to receiving the two-way radio communication session initiation signal. The communication session initiation module 450 of the PoC server 106 can process the two-way radio communication session initiation signal and coordinate the establishment of the two-way radio communication session. The PoC server 106 can transmit a two-way radio communication session invitation to the additional UE 102N via the base station 104N to prompt the additional UE 102N to join the two-way radio communication session.

As further shown in FIG. 8, the two-way radio communication session initiated in the step 812 can utilize the communication network 100 to transmit data between the first UE 102A and the additional UE 102N over a cellular data connection. The two-way radio communication session can bypass the cellular phone network, such that voice and data transmission occurs over cellular data infrastructure rather than the public switched telephone network (PSTN). The two-way radio communication session can support transmission of voice data, video data, text data, location data, or a combination thereof between the first UE 102A and the additional UE 102N. The method 800 then proceeds to an End terminal, completing the process for pre-establishing and initiating the two-way radio communication session.

The disclosed technology can be further understood according to the following clauses:
Clause 1: A mobile phone application stored on a non-transitory computer-readable medium and executable by a processor of a mobile phone, the mobile phone application comprising: instructions that, when executed by the processor, cause the mobile phone to: detect an initiation of a phone call by a user to a recipient via a cellular phone network; intercept the phone call prior to establishing a connection via the cellular phone network; transmit a two-way radio communication session initiation signal to a server; and establish a two-way radio communication session between the mobile phone and a mobile phone of the recipient over a cellular data connection, wherein the two-way radio communication session bypasses the cellular phone network.
Clause 2: The mobile phone application of clause 1, wherein the instructions further cause the mobile phone to receive, from the server, two-way radio communication session information prior to detecting the initiation of the phone call.
Clause 3: The mobile phone application of clause 2, wherein the two-way radio communication session information comprises one or more of control data, configuration data, user data, security data, or a combination thereof.
Clause 4: The mobile phone application of clause 3, wherein the instructions further cause the mobile phone to store the two-way radio communication session information in a memory module of the mobile phone.
Clause 5: The mobile phone application of clause 1, wherein the instructions further cause the mobile phone to receive input from one or more action buttons on sides of the mobile phone to facilitate the two-way radio communication session.
Clause 6: The mobile phone application of clause 5, wherein the two-way radio communication session is maintained while the one or more action buttons are depressed and terminates when the one or more action buttons are released.
Clause 7: The mobile phone application of clause 1, wherein the instructions further cause the mobile phone to transmit two-way radio communication session data comprising one or more of voice data, video data, text data, location data, or a combination thereof.
Clause 8: The mobile phone application of clause 1, wherein the instructions further cause the mobile phone to maintain a continuous two-way radio communication session connection with the server that runs in a background of an operating system of the mobile phone.
Clause 9: The mobile phone application of clause 1, wherein the instructions further cause the mobile phone to transmit a two-way radio communication session termination request to the server in response to the user ending the two-way radio communication session.
Clause 10: A method for establishing a two-way radio communication session, the method comprising: detecting, by a mobile phone application executing on a first mobile phone, an initiation of a phone call by a user of the first mobile phone to a second mobile phone via a cellular phone network; intercepting, by the mobile phone application, the phone call prior to establishing a connection via the cellular phone network; transmitting, by the mobile phone application, a two-way radio communication session initiation signal to a server; receiving, by the server, the two-way radio communication session initiation signal; and initiating, by the server, a two-way radio communication session between the first mobile phone and the second mobile phone over a cellular data connection, wherein the two-way radio communication session bypasses the cellular phone network.
Clause 11: The method of clause 10, further comprising pre-establishing, by the server, a two-way radio communication session connection with the first mobile phone prior to detecting the initiation of the phone call.
Clause 12: The method of clause 11, wherein pre-establishing the two-way radio communication session connection comprises transmitting, by the server, two-way radio communication session information to the first mobile phone.
Clause 13: The method of clause 12, wherein the two-way radio communication session information comprises one or more of control data, configuration data, user data, security data, or a combination thereof.
Clause 14: The method of clause 10, further comprising transmitting, by the server, a two-way radio communication session invitation to the second mobile phone.
Clause 15: The method of clause 10, further comprising receiving input from one or more action buttons on sides of the first mobile phone to facilitate the two-way radio communication session, wherein the two-way radio communication session is maintained while the one or more action buttons are depressed.
Clause 16: The method of clause 10, further comprising transmitting, via the two-way radio communication session, two-way radio communication session data comprising one or more of voice data, video data, text data, location data, or a combination thereof between the first mobile phone and the second mobile phone.
Clause 17: A system for two-way radio communication over cellular data, the system comprising: a first mobile phone having a processor and a memory storing a mobile phone application executable by the processor; a second mobile phone; and a server in communication with the first mobile phone and the second mobile phone over a cellular data network; wherein the mobile phone application is configured to: detect an initiation of a phone call by a user of the first mobile phone to the second mobile phone via a cellular phone network; intercept the phone call prior to establishing a connection via the cellular phone network; and transmit a two-way radio communication session initiation signal to the server; and wherein the server is configured to establish a two-way radio communication session between the first mobile phone and the second mobile phone over the cellular data network, wherein the two-way radio communication session bypasses the cellular phone network.
Clause 18: The system of clause 17, wherein the server is further configured to pre-establish a two-way radio communication session connection with the first mobile phone prior to detecting the initiation of the phone call, and wherein the mobile phone application is configured to maintain the two-way radio communication session connection in a background of an operating system of the first mobile phone.

Clause 19: The system of clause 18, wherein the server is further configured to transmit two-way radio communication session information to the first mobile phone, wherein the two-way radio communication session information comprises one or more of control data, configuration data, user data, security data, or a combination thereof.

Clause 20: The system of clause 17, wherein the first mobile phone comprises one or more action buttons on sides of the first mobile phone, and wherein the mobile phone application is configured to receive input from the one or more action buttons to facilitate the two-way radio communication session, wherein the two-way radio communication session is maintained while the one or more action buttons are depressed.

A number of implementations have been described. Nevertheless, it will be understood that various modifications may be made without departing from the spirit and scope of the disclosure. Accordingly, other implementations are within the scope of the following claims.

1. A mobile phone application stored on a non-transitory computer-readable medium and executable by a processor of a mobile phone, the mobile phone application comprising:
instructions that, when executed by the processor, cause the mobile phone to:
detect an initiation of a phone call by a user to a recipient via a cellular phone network;
intercept the phone call prior to establishing a connection via the cellular phone network;
transmit a two-way radio communication session initiation signal to a server; and
establish a two-way radio communication session between the mobile phone and a mobile phone of the recipient over a cellular data connection, wherein the two-way radio communication session bypasses the cellular phone network.

2. The mobile phone application of claim 1, wherein the instructions further cause the mobile phone to receive, from the server, two-way radio communication session information prior to detecting the initiation of the phone call.

3. The mobile phone application of claim 2, wherein the two-way radio communication session information comprises one or more of control data, configuration data, user data, security data, or a combination thereof.

4. The mobile phone application of claim 3, wherein the instructions further cause the mobile phone to store the two-way radio communication session information in a memory module of the mobile phone.

5. The mobile phone application of claim 1, wherein the instructions further cause the mobile phone to receive input from one or more action buttons on sides of the mobile phone to facilitate the two-way radio communication session.

6. The mobile phone application of claim 5, wherein the two-way radio communication session is maintained while the one or more action buttons are depressed and terminates when the one or more action buttons are released.

7. The mobile phone application of claim 1, wherein the instructions further cause the mobile phone to transmit two-way radio communication session data comprising one or more of voice data, video data, text data, location data, or a combination thereof.

8. The mobile phone application of claim 1, wherein the instructions further cause the mobile phone to maintain a continuous two-way radio communication session connection with the server that runs in a background of an operating system of the mobile phone.

9. The mobile phone application of claim 1, wherein the instructions further cause the mobile phone to transmit a two-way radio communication session termination request to the server in response to the user ending the two-way radio communication session.

10. A method for establishing a two-way radio communication session, the method comprising:
detecting, by a mobile phone application executing on a first mobile phone, an initiation of a phone call by a user of the first mobile phone to a second mobile phone via a cellular phone network;
intercepting, by the mobile phone application, the phone call prior to establishing a connection via the cellular phone network;
transmitting, by the mobile phone application, a two-way radio communication session initiation signal to a server;
receiving, by the server, the two-way radio communication session initiation signal; and
initiating, by the server, a two-way radio communication session between the first mobile phone and the second mobile phone over a cellular data connection, wherein the two-way radio communication session bypasses the cellular phone network.

11. The method of claim 10, further comprising pre-establishing, by the server, a two-way radio communication session connection with the first mobile phone prior to detecting the initiation of the phone call.

12. The method of claim 11, wherein pre-establishing the two-way radio communication session connection comprises transmitting, by the server, two-way radio communication session information to the first mobile phone.

13. The method of claim 12, wherein the two-way radio communication session information comprises one or more of control data, configuration data, user data, security data, or a combination thereof.

14. The method of claim 10, further comprising transmitting, by the server, a two-way radio communication session invitation to the second mobile phone.

15. The method of claim 10, further comprising receiving input from one or more action buttons on sides of the first mobile phone to facilitate the two-way radio communication session, wherein the two-way radio communication session is maintained while the one or more action buttons are depressed.

16. The method of claim 10, further comprising transmitting, via the two-way radio communication session, two-way radio communication session data comprising one or more of voice data, video data, text data, location data, or a combination thereof between the first mobile phone and the second mobile phone.

17. A system for two-way radio communication over cellular data, the system comprising:
a first mobile phone having a processor and a memory storing a mobile phone application executable by the processor;
a second mobile phone; and
a server in communication with the first mobile phone and the second mobile phone over a cellular data network;
wherein the mobile phone application is configured to:
detect an initiation of a phone call by a user of the first mobile phone to the second mobile phone via a cellular phone network;
intercept the phone call prior to establishing a connection via the cellular phone network; and
transmit a two-way radio communication session initiation signal to the server; and
wherein the server is configured to establish a two-way radio communication session between the first mobile phone and the second mobile phone over the cellular data network, wherein the two-way radio communication session bypasses the cellular phone network.

18. The system of claim 17, wherein the server is further configured to pre-establish a two-way radio communication session connection with the first mobile phone prior to detecting the initiation of the phone call, and wherein the mobile phone application is configured to maintain the two-way radio communication session connection in a background of an operating system of the first mobile phone.

19. The system of claim 18, wherein the server is further configured to transmit two-way radio communication session information to the first mobile phone, wherein the two-way radio communication session information comprises one or more of control data, configuration data, user data, security data, or a combination thereof.

20. The system of claim 17, wherein the first mobile phone comprises one or more action buttons on sides of the first mobile phone, and wherein the mobile phone application is configured to receive input from the one or more action buttons to facilitate the two-way radio communication session, wherein the two-way radio communication session is maintained while the one or more action buttons are depressed.
